(19) United States
(12) Patent Application Publication
(10) Pub. No.: US 2020/0187536 A1
(43) Pub. Date: Jun. 18, 2020

(54) Table salts and the manufacturing methods and system

(71) Applicants: TSINGHUA UNIVERSITY, Beijing (CN); SICHUAN ZIGONG CHI YU SALT PRODUCT CO., LTD., Zigong, Sichuan (CN)

(72) Inventors: Xuebing ZHAO, Beijing (CN); Dehua LIU, Beijing (CN); Lingmei DAI, Beijing (CN); Chenghua ZOU, Zigong, Sichuan (CN); Guilan YU, Zigong, Sichuan (CN)

(21) Appl. No.: 16/642,377

(22) PCT Filed: Mar. 19, 2018
(86) PCT No.: PCT/CN2018/079441

§ 371 Date: Feb. 27, 2020

(30) Foreign Application Priority Data
Aug. 28, 2017 (CN) 201710751170.7

(51) Int. Cl. A23L 27/40; C01D 3/08; B01D 1/26

(52) U.S. Cl. CPC A23L 27/40; C01D 3/08; C01P 2006/80; A23V 2002/00; B01D 1/26

(57) ABSTRACT

The present invention provides table salts. The said table salts contains 50 to 600 mg/kg of strontium. The strontium-rich table salts provided by the present invention has significantly higher strontium content than traditional common table salts. As one of the essential trace elements, strontium plays an important role in human health. The said table salts provided by the present invention are rich in strontium, which can be assimilated by human body during taking the said table salts. Moreover, the strontium content in the table salts provided by the present invention ranges from 50 to 600 mg/kg, which enables human body to get enough strontium to meet human needs when taking normal amount of the said table salts daily.

### FIELD OF THE INVENTION

The invention described herein relates to the field of food technology. In particular, the invention relates to table salts and the manufacture methods and system thereof.

### BACKGROUND

Table salt, also known as edible salt, is one of the most important substances for human survival and the most commonly used seasoning in cooking. The main component of table salt is sodium chloride. There are two types of table salt, namely coarse table salt and refined table salt. Coarse salt can be obtained by boiling, filtering, steaming and crystallization of seawater, aqueous solution of mineral salt, brine from salt wells and salt water from salt ponds. Refined salt is manufactured by recrystallization of coarse salt and chemical removal of impurities such as sulfate and sodium carbonate of alkali and alkaline earth metals. With the continuous improvement of people's living standards, people have higher requirements on the safety and nutrition of food that they take. As the most widely used food flavoring agent and nutrient, the development of green and natural healthy salt containing trace elements has been increasingly concerned by people.

Strontium is one of the essential trace elements in the human body, which is closely related to the formation of human bones, and is the main component of bones and teeth. Strontium is found in all tissues of the body, and it competes with sodium in the intestinal absorption site, which reduces the absorption of sodium in the human body and thus is conducive to normal cardiovascular activities. Strontium can be used to treat convulsions caused by parathyroid insufficiency, while strontium deficiency may cause dental caries. The enrichment of strontium in food is related to the local water quality and soil. Generally speaking, adults can meet the physiological needs by taking strontium of 2 mg every day. Strontium-rich mineral water with content of below 5 mg/L is beneficial to human health, but will not cause adverse effects. Strontium is regarded as one of the essential components by the “Chinese standard for drinking mineral water GB8537-87”, and is regarded as the boundary index and limit index, which stipulates that the content of strontium in mineral water is 0.2˜0.5 mg/L (Wu Mao-jiang. The Relationship Between Strontium and Human Health. Studies of Trace Elements and Health, 2012,29 (5): 66-67).

Nowadays, cardiovascular diseases caused by excessive sodium intake are getting more and more attention. Studies have shown that strontium levels in drinking water and urine are negatively correlated with hypertensive heart disease. The ratio of sodium/strontium in drinking water was positively correlated with vascular injury, arteriosclerosis, degenerative heart disease and hypertensive heart disease of the central nervous system. The ratio of sodium/strontium in urine was significantly negatively correlated with systemic arteriosclerosis (Liam; Ziyu, Yang ping, Li Zhongcheng. Research progress on the relation between strontium and cardiovascular diseases. People's Military Surgeon, 2007, 50(12): 768-769). The excessive sodium in the body is the major reason for the occurrence of hypertension and cardiovascular disease. Strontium is also related to the vascular function and structure. It is proposed that strontium in intestinal can compete with sodium absorption site, which can reduce the absorption of sodium by the body and increase the excretion of sodium by urination, and thus reducing the sodium content in the body. Therefore, strontium can effectively prevent hypertension and cardiovascular disease. However, excessive strontium intake can also have negative impact on the human body, causing excessive growth of bones causing joint and bone deformation, enlargement, fragility, pain, muscular atrophy and anemia, etc. (Wu Mao Jiang. The Relationship Between Strontium and Human Health. Studies of Trace Elements and Health, 2012,29 (5): 66-67)

Table salt is an essential condiment of daily diet, especially in Asia. If a certain amount of strontium is contained in the salt, it can supplement some strontium to the human body, which would play a positive role in promoting bone development and preventing cardiovascular diseases. However, there is no standard available for the content of strontium in table salt, and the content of strontium in existing table salt is very low. Therefore, obtaining table salt containing suitable proportion of strontium is the key problem to be solved for developing strontium-rich table salt

### SUMMARY OF THE INVENTION

This application is based on the inventors' discovery and knowledge on the following facts and issues:

Too much salt intake can cause a variety of cardiovascular diseases. The world health organization (WHO) recommends that the salt intake amount of per person is less than 6 grams per day, usually between 2.5 and 6 grams per day. If the daily intake amounts of salt and strontium are assumed to be 6 g and 2 mg, respectively, the minimum content of strontium in the table salt could be 330 mg/kg. Adults should drink at least 2 L of water every day, and the water containing strontium 5 mg/L will not have adverse effects on the human body, so the daily intake amount of strontium per person can be as high as 10 mg. This suggests that the table salt with a strontium content as high as 1650 mg/kg is also safe for human body. On the other hand, by referring to the strontium-rich mineral water with strontium content of 0.2-0.5 mg/L, if a person takes 2-3 L of water or intakes 2.5-6 g of salt every day, it can be known that the content range of strontium in table salt can be 66-600 mg/kg. Based on the above analysis, the applicant believes that the strontium content in table salt at 50-600 mg/kg is appropriate and safe.

The present invention aims at solving, at least to a certain extent, one of the technical issues in the related technology.

Therefore, in a first aspect, the present invention provides table salts According to the embodiments of the present invention, the said table salts contain strontium elements of 50-600 mg/kg. The strontium-rich table salts provided by the invention has significantly higher strontium content than traditional table salt. Strontium, as one of the essential trace elements, plays an important role in human health. The table salts provided by the invention are rich in strontium that can be simultaneously gained by human body while taking the said table salt. Moreover, the strontium content in the table salts provided by the present invention ranges from 50 to 600 mg/kg, which enables human body to get the strontium amount that can meet human needs when normal salt amount is taken.

According to embodiments of the present invention, the said table salts may further include at least one of the following additional technical characteristics:

According to embodiments of the present invention, the said table salts further contain sodium chloride with mass fraction greater than or equal to 99.1%, sulfate ion less than or equal to 0.4%, and moisture content less than or equal to 0.3%. According to embodiments of the invention, the strontium element exists in one or more forms of strontium chloride, strontium sulfate or strontium carbonate. Therefore, the enrichment of strontium in the table salt will not introduce other anions that are not needed by the human body or harmful to the human body.

In the second aspect, the present invention provides methods for manufacturing the said table salts mentioned above. According to the embodiments of the present invention, the said method comprises the steps of: (1) pretreatment of the raw brine to obtain pretreated brine;(2) evaporation of the said pretreated brine obtained in step a) by a multi-effect evaporation process to obtain concentrated brine and gypsum mother liquor; and (3) post-treatment of the concentrated brine obtained in step (2) by thickening and drying to obtain off-gas and the said table salt. According to the method provided by the embodiment of the present invention, the strontium in the raw brine can be enriched into the said table salt, and the strontium content in the said table salts can be effectively controlled, so as to obtain the said table salt product with strontium content of 50-600 mg/kg.

According to embodiments of the present invention, the said method for manufacturing the said table salts may further includes at least one of the following additional technical characteristics:

According to embodiments of the present invention, the raw brine is mine brine. Mine brine usually contains a certain amount of strontium, which can be used as a natural raw brine for manufacturing the said strontium-rich salt.

According to the embodiments of the present invention, the mass ratio of sodium to strontium in the said pretreated brine is 3000:1-100:1, and the mass ratio of calcium to strontium is 150:1-10:1. Stable content of strontium in the said table salt products can be obtained by adjusting the ratios of sodium to strontium and calcium to strontium in the said pretreated brine before evaporation. The inventor found that relatively stable strontium content of 50-600 mg/kg in the said table salt products could be obtained when the mass ratio of sodium to strontium in the said pretreated brine was 3000:1-:100:1 and the mass ratio of calcium to strontium was 150:1-10:1.

According to the embodiments of the present invention, the said pretreatment in step (1) includes one or more combinations of pH adjustment, electrodialysis treatment, ion exchange treatment and membrane filtration treatment. The mass ratio of sodium to strontium and calcium to strontium in the pretreated brine can be controlled within the range of 3000:1-100:1 and 150:1-10:1, respectively, by using the above pretreatment methods.

According to the embodiments of the present invention, the pH adjustment is conducted by one or more combinations of sodium carbonate, sodium bicarbonate, sodium hydroxide, calcium chloride, calcium sulfate, calcium carbonate and calcium oxide. This is based on the consideration of the difference in the solubility of strontium chloride, strontium sulfate and strontium carbonate in water.

According to the embodiments of the present invention, the pH of the pretreated brine is 7-11.The inventor found that in pH of 7-11, the mass ratios of sodium to strontium and calcium to strontium in the pretreated brine could be effectively controlled at 3000:1-100:1 and 150:1-10:1, respectively.

According to the embodiments of the present invention, the electrodialysis treatment is performed with bipolar membrane electrodialysis. Sodium ions, calcium ions and strontium ions have different electromigration behaviors in the electrodialysis process, and the anions and cations can be effectively separated by using bipolar membrane electrodialysis, so as to obtain the required mass ratios of sodium to strontium and calcium to strontium.

According to the embodiments of the present invention, the membrane filtration treatment is nanofiltration. Membrane filtration treatment has different retention rates for ions of brine, especially the nanofiltration, which can effectively retain divalent ions, while the salt containing monovalent ions, such as sodium chloride, can effectively pass through the nanofiltration membrane. The ratios of sodium to strontium and calcium to strontium of the brine to be treated is thus can be conveniently adjusted.

According to the embodiments of the present invention, the said multi-effect evaporation of step (2) is selected as two-effect to six-effect evaporation to minimize the amount of steam needed for evaporation of water.

According to embodiments of the invention, the said multi-effect evaporation is performed as concurrent, countercurrent, cross-flow or combination thereof to optimize the evaporation efficiency and minimize energy consumption.

According to the embodiments of the present invention, the pretreated brine obtained by pretreatment in step (1) is further treated by multi-effect evaporation to obtain concentrated brine, and the said multi-effect evaporation is performed by countercurrent, so as to minimize the energy consumption required by evaporation.

According to the embodiments of the present invention, the pretreated brine obtained by pretreatment in step (1) is further treated by multi-effect evaporation to obtain gypsum mother liquor, and the said multi-effect evaporation is performed by concurrent, which on the one hand can increase the residence time of gypsum in evaporation process to make the precipitation of gypsum from the brine more completely, and on the other hand can make the gypsum flow into the evaporators of different effect as a crystal seed to reduce the evaporator scaling.

According to the embodiments of the present invention, the evaporation times of gypsum mother liquor obtained by multi-effect evaporation treatment are different from the evaporation times of concentrated brine obtained by multi-effect evaporation treatment.

According to the embodiments of the present invention, the temperature of multi-effect evaporation decreases from the first effect to the last effect at a temperature gradient of 10-30° C., so as to obtain a reasonable temperature difference.

According to the embodiments of the present invention, the first effect evaporation is carried out at the temperature of 120-180° C. at an absolute pressure of 0.2-10 MPa, so that the temperature of the last effect can be maintained at 30-50° C., and the steam discharged from this effect can be cooled by cooling water at surrounding temperature.

According to the embodiments of the present invention, the method for manufacturing the said Table salts further comprises: step (4) in which the gypsum mother liquor obtained by step (2) is centrifuged to obtain gypsum and supernatant; step (5) in which the salt-containing off-gas obtained from step (3) is treated with dry de-dedusting treatment, and then treated by wet de-dusting with the supernatant obtained from step (4) and/or the condensed water obtained from the multi-effect evaporation in step (2), so as to obtain de-dusting brine; step (6) in which the de-dusting brine obtained in step (5) is mixed with the pre-treated brine obtained in step (1) and then evaporated and concentrated so as to obtain the said salt.

According to the embodiments of the present invention, step (6) is performed when the concentration of salt in the de-dusting brine obtained in step (5) reaches 150-300 g/L, so as to minimize the amount of water to be evaporated in the subsequent evaporation.

According to the embodiments of the present invention, step (2) further includes the step to collect the concentrated brine containing different strontium content from different evaporation chambers of the multi-effect evaporation system. Namely, according to the difference in the ratios of sodium to strontium and calcium to strontium in the pretreated brine, salt products with different strontium content can be obtained from the evaporation chamber of multi-effect evaporation system. Thus, a series of table salt products with different strontium content can be manufactured from the same brine.

In a third aspect of the invention, a system for manufacturing the said salt is provided in this disclosure. According to the embodiments of the present invention, the system includes: the pretreatment equipment, which is used to pretreat the raw brine to obtain the pretreated brine; Multi-effect evaporation equipment. The multi-effect evaporation equipment is connected with the pretreatment equipment, which is used to obtain concentrated brine and gypsum mother liquor after the pretreatment by multi-effect evaporation treatment. The thickening and drying equipment, which is connected with the multi-effect evaporation equipment, is used to thicken and dry the concentrated brine obtained from the multi-effect evaporation equipment to obtain the off-gas containing salt and the said table salt. According to the embodiments of the present invention, the above said salt manufacture system can effectively enrich or control the amount of strontium of the raw brine into the said salt products, so as to efficiently obtain the table salt products with strontium content of 50-600 mg/kg, which is easy to scale-up for industrial production.

According to the embodiments of the present invention, the system further includes at least one of the following additional technical features:

According to the embodiments of the present invention, the system further includes:

Gypsum treatment equipment, which is connected with the multiple-effect evaporation equipment and used to centrifuge the mother liquid of gypsum obtained by the multiple-effect evaporation equipment to obtain gypsum and supernatant;

Dry de-dusting equipment, which is connected with the thickening and drying equipment for removal of the salt-containing off-gas obtained by the thickening and drying equipment;

Wet de-dusting equipment, which is connected with dry de-dusting equipment plant, the gypsum treatment equipment, and/or multi-effect evaporation equipment. The said Wet de-dusting equipment is used to removal the salt in the salt-containing off-gas from the dry de-dusting equipment with the supernatant obtained from gypsum treatment equipment and/or the condensed water obtained from the multi-effect evaporation equipment. De-dusting brine is obtained from the said we de-dusting equipment; and

Brine mixing equipment, which is connected with the wet de-dusting equipment, the pretreatment equipment and the multi-effect evaporation equipment. Brine mixing equipment is used to mix the de-dusting brine obtained from the wet de-dusting equipment with the brine obtained from the pretreatment equipment; the mixed brine is then transferred back to the multi-effect evaporation equipment.

### DESCRIPTION OF THE DRAWINGS

FIG. 1 shows a schematic diagram of the system for manufacturing the said table salts according to an embodiment of the present invention

FIG. 2 shows a schematic diagram of the system for manufacturing the said table salts according to another embodiment of the present invention

FIG. 3 shows a flowsheet schematic diagram for manufacture of strontium-rich table salts from brine according to an embodiment of the present invention

FIG. 4 shows a flowsheet schematic diagram for manufacture of strontium-rich table salts from brine according to another embodiment of the present invention;

FIG. 5 shows a flowsheet schematic diagram for manufacture of strontium-rich table salts from brine according to another embodiment of the present invention;

### MODES FOR CARRYING OUT THE INVENTION

To further illustrate the invention, the following examples are provided. These examples are provided for description of the present invention, but no intention to limit the scope of the invention.

### Table Salts

In a first aspect, the prevent invention provides table salts. According to the embodiments of the present invention, the said table salts contain strontium elements of 50-600 mg/kg.

According to embodiments of the present invention, the said table salts further contain sodium chloride with mass fraction greater than or equal to 99.1%, sulfate ion less than or equal to 0.4%, and moisture content less than or equal to 0.3%.

According to embodiments of the invention, the strontium element exists in one or more forms of strontium chloride, strontium sulfate or strontium carbonate.

The strontium-rich table salts provided by the invention has significantly higher strontium content than traditional table salts. Strontium, as one of the essential trace elements, plays an important role in human health. The table salts provided by the invention is rich in strontium that can be simultaneously gained by human body while taking the said table salts. Moreover, the strontium content in the table salts provided by the present invention ranges from 50 to 600 which enables human body to get the strontium amount that can meet human needs when normal salt amount is taken.

### Methods for Manufacturing the Said Table Salts

In a second aspect, the invention provides the methods for manufacturing the said table salts as described herein.

According to the embodiments of the present invention, the said method comprises the steps of: (1) pretreatment of the raw brine to obtain pretreated brine; (2) evaporation of the said pretreated brine obtained in step a) by a multi-effect evaporation process to obtain concentrated brine and gypsum mother liquor; and (3) post-treatment of the concentrated brine obtained in step (2) by thickening and drying to obtain off-gas and the said table salts.

According to the embodiments of the present invention, the methods for manufacturing the said table salts further comprises: step (4) in which the gypsum mother liquor obtained by step (2) is centrifuged to obtain gypsum and supernatant; step (5) in which the salt-containing off-gas obtained from step (3) is treated with dry de-dedusting treatment, and then treated by wet de-dusting with the supernatant obtained from step (4) and/or the condensed water obtained from the multi-effect evaporation in step (2), so as to obtain de-dusting brine; step (6) in which the de-dusting brine obtained in step (5) is mixed with the pre-treated brine obtained in step (1) and then evaporated and concentrated so as to obtain the said salt.

According to embodiments of the present invention, the raw brine is mine brine.

According to the embodiments of the present invention, the mass ratio of sodium to strontium in the said pretreated brine is 3000:1-100:1, and the mass ratio of calcium to strontium is 150:1-10:1.

According to the embodiments of the present invention, the said pretreatment in step (1) includes one or more combinations of pH adjustment, electrodialysis treatment, ion exchange treatment and membrane filtration treatment.

According to the embodiments of the present invention, the pH adjustment is conducted by one or more combinations of sodium carbonate, sodium bicarbonate, sodium hydroxide, calcium chloride, calcium sulfate, calcium carbonate and calcium oxide.

According to the embodiments of the present invention, the pH of the pretreated brine is 7-11.

According to the embodiments of the present invention, the electrodialysis treatment is performed with bipolar membrane electrodialysis.

According to the embodiments of the present invention, the membrane filtration treatment is nanofiltration.

According to the embodiments of the present invention, the said multi-effect evaporation of step (2) is selected as two-effect to six-effect evaporation.

According to embodiments of the invention, the said multi-effect evaporation is performed as concurrent, countercurrent, cross-flow or combination thereof.

According to the embodiments of the present invention, the pretreated brine obtained by pretreatment in step (1) is further treated by multi-effect evaporation to obtain concentrated brine, and the said multi-effect evaporation is performed by countercurrent.

According to the embodiments of the present invention, the pretreated brine obtained by pretreatment in step (1) is further treated by multi-effect evaporation to obtain gypsum mother liquor, and the said multi-effect evaporation is performed by concurrent.

According to the embodiments of the present invention, the evaporation times of gypsum mother liquor obtained by multi-effect evaporation treatment are different from the evaporation times of concentrated brine obtained by multi-effect evaporation treatment.

According to the embodiments of the present invention, the temperature of multi-effect evaporation decreases from the first effect to the last effect at a temperature gradient of 10-30° C.

According to the embodiments of the present invention, the first effect evaporation is carried out at the temperature of 120-180° C. at an absolute pressure of 0.2-10 MPa.

According to the embodiments of the present invention, step (6) is performed when the concentration of salt in the de-dusting brine obtained in step (5) reaches 150-300 g/L.

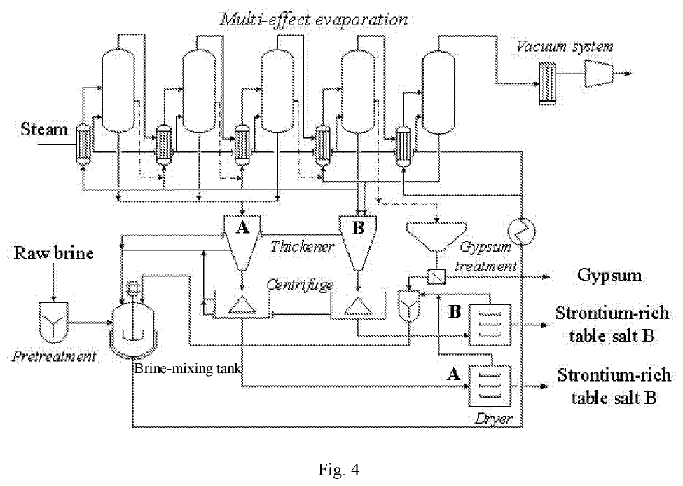

According to the embodiments of the present invention, step (2) further includes the step to collect the concentrated brine containing different strontium content from different evaporation chambers of the multi-effect evaporation system. Namely, according to the difference in the ratios of sodium to strontium and calcium to strontium in the pretreated brine, salt products with different strontium content can be obtained from the evaporation chamber of multi-effect evaporation system. As shown in FIG. 4, concentrated brine can be discharged from the evaporators of different effect, and used to manufacture the said table salts after processing by thickening and drying. Because the evaporation condition is different in different evaporators, the content of strontium in the obtained table salts are thus different. Thus, a series of table salt products with different strontium content can be manufactured from the same brine.

The present invention also provides the methods for manufacturing the said table salts. Since the ratios of sodium, calcium and strontium in brine from mines are not fixed, it is necessary to adjust the sodium/strontium ratio and calcium/strontium ratio before evaporation in order to obtain relatively stable strontium content in the salt product. On the one hand, this method is developed according to the principle that the solubility of strontium salt, namely strontium chloride, strontium sulfate, strontium carbonate, etc. in water is different and related to the pH value of the system. In addition, sodium ions, calcium ions and strontium ions have different electrornigration behaviors in the electrodialysis process, and different exchange behaviors with ion exchange resin in the ion exchange process, and therefore different sodium-strontium ratios and calcium-strontium ratios can be obtained by controlling the processing conditions. On the other hand, membrane filtration treatment has different interception rate for the ions in brine, especially nanofiltration, which can effectively reject divalent ions, while salt containing one valent ions, such as sodium chloride, can effectively pass through the nanofiltration membrane. Therefore, it is convenient to adjust the ratio of sodium to strontium and calcium to strontium in the pretreated brine. In addition, when certain calcium sulfate solids exist in the system, strontium element will be precipitated together with calcium. Moreover, during the vacuum evaporation process, the amount of precipitated strontium sulfate and strontium carbonate can be controlled by controlling the residence time and evaporation conditions, thus controlling the strontium content in the table salt products. To sum up, the strontium-rich salt products provided by the present invention are table salt products with strontium element content of 50-600 mg/kg by enriching or controlling the strontium in the raw brine into the table salt products through a combination of various means.

### System for Manufacturing the Said Table Salts

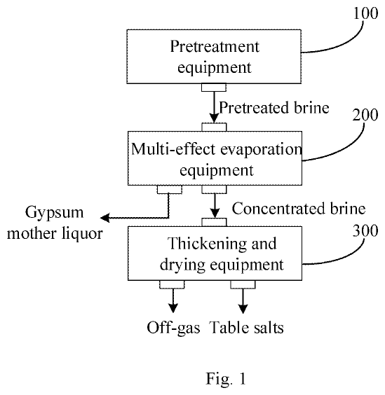

In a third aspect of the invention, the present invention provides a system for manufacturing the said salt. According to the embodiments of the present invention, as shown in FIG. 1, the system includes: the pretreatment equipment 100, which is used to pretreat the raw brine to obtain the pretreated brine; Multi-effect evaporation equipment 200, which is connected with the pretreatment equipment 100, and used to evaporate the pretreated brine from pretreatment equipment 100 by multi-effect evaporation to obtain concentrated brine and gypsum mother liquor; Thickening and drying equipment 300, which is connected with the multi-effect evaporation equipment 200, and used to thicken and dry the concentrated brine obtained from the multi-effect evaporation equipment 200 to obtain the salt-containing off-gas and the said table salts.

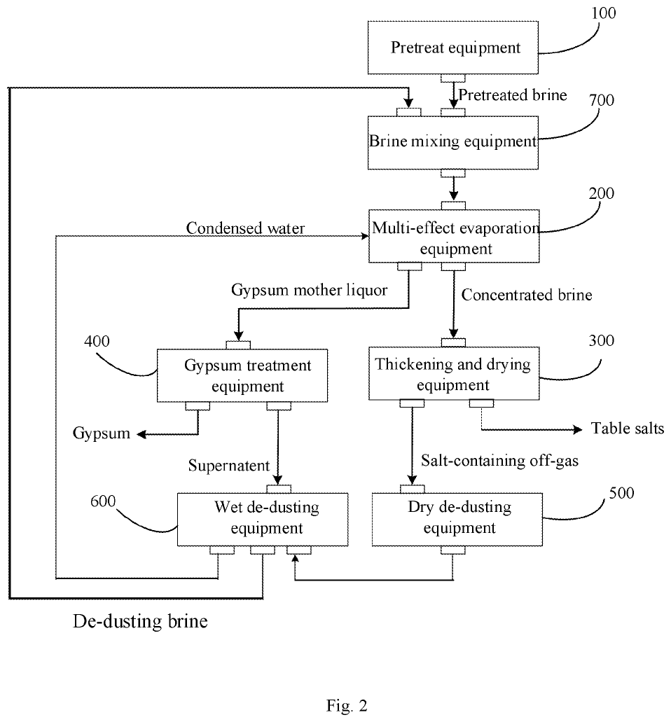

According to the embodiments of the present invention, as shown in FIG. 2, the above said system for manufacture of the said table salts further includes: Gypsum treatment equipment 400, which is connected with the multiple-effect evaporation equipment 200, and used to centrifuge the mother liquid of gypsum obtained from the multiple-effect evaporation equipment 200 to obtain gypsum and supernatant; Dry de-dusting equipment 500, which is connected with the thickening and drying equipment 400, and used for removal of the salt-containing off-gas obtained by the thickening and drying equipment 400; Wet de-dusting equipment 600, which is connected with dry de-dusting equipment 500, the gypsum treatment equipment 400, and/or multi-effect evaporation equipment 200, and is used to remove the salt in the salt-containing off-gas from the dry de-dusting equipment 500 with the supernatant from gypsum treatment equipment 400 and/or the condensed water from the multi-effect evaporation equipment 200; and brine mixing equipment 700, which is connected with the wet de-dusting equipment 600, the pretreatment equipment 100 and the multi-effect evaporation equipment 200, and is used to mix the de-dusting brine from the wet de-dusting equipment 600 with the pretreated brine obtained from the pretreatment equipment 200. The mixed brine is then transferred back to the multi-effect evaporation equipment 200.

According to the embodiments of the present invention, the above said system for manufacture of the said table salts can effectively enrich or control the amount of strontium of the raw brine into the said salt products, so as to efficiently obtain the said table salt products with strontium content of 50-600 mg/kg, which is easy to scale-up for industrial production.

### EXAMPLES

### Example 1

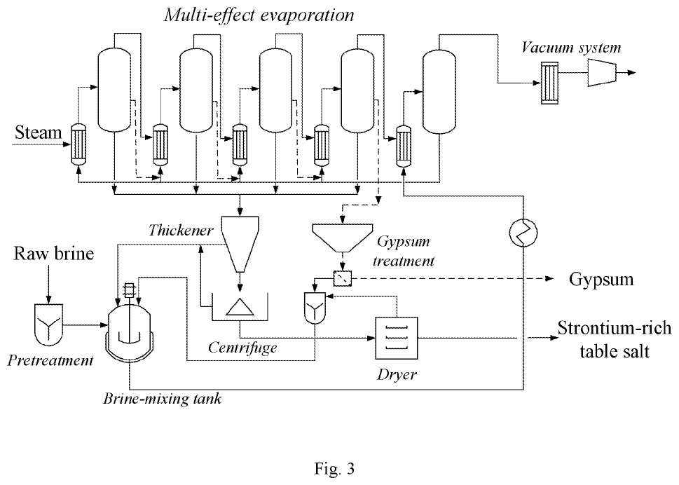

The raw brine used in the practical production contained 124900 mg/L sodium, 4500 mg/L calcium and 260 mg/L strontium. The raw brine was condensed and crystallized according to the process shown in FIG. 3. The raw brine was pretreated with food-grade sodium carbonate and calcium sulfate to adjust the pH value of the pretreated brine to 7.0. The ratios of sodium/strontium and sodium/calcium were 545:1 and 145:1 after pretreatment. The pretreated brine was mixed in the brine mixing tank, and then sent to the V-effect evaporator of the five-effect evaporation system. The brine discharged from V-effect evaporator was then distributed evenly to the I to IV-effect evaporators. The temperature and pressure of the heating chamber of effect I to V are respectively controlled at 140° C./0.35 Mpa, 120° C./0.19 mpa, 100° C./0.094 Mpa, 80° C./0.045 Mpa and 60° C./0.021 Mpa. The I-effect evaporator was heated by external steam, while other evaporator was heated by the steam from the last effect evaporator. The salt slurry discharged from each evaporator chamber was sent to the thickener and then dewatered by centrifugation. The obtained mother liquor was returned to the brine mixing tank and mixed with the pretreated brine. The wet salt from the centrifuge was sent to the drying equipment mainly comprising fluidized bed dryer for drying, and strontium-rich salts were obtained as the products. By elementary analysis, the content of sodium chloride in this product was 99.3%, the content of sulfate group was 0.3% and the content of strontium was 277 mg/kg. The gypsum mother liquor flowed from I-effect evaporator to the IV-effect evaporator and discharged to the settling pool. After settling, the supernatant was used to deal with the salt-containing off-gas from the drying equipment to obtain de-dusting brine, where the off-gas was previously treated by cyclone separator. When the salt content reached 200 g/L, the obtained de-dusting brine was sent back to the brine mixing tank. The gypsum slurry was filtered by plate filter press to get gypsum. The content of calcium in gypsum was 22.6% and strontium content was 0.6%.

### Example 2

The used raw brine and process of concentrated crystallization were the same to that of Example 1, but in the pretreatment process, food-grade sodium carbonate and calcium sulfate were used for pretreatment to adjust the pH value of the pretreated bine to 9.0. The ratios of sodium/strontium and sodium/calcium in the pre-treated brine were 850:1 and 255:1, respectively. The strontium content of the table salt product manufactured according to the above process was 152 mg/kg.

### Example 3

The used raw brine and process of concentrated crystallization were the same to that of Example 1, but in the pretreatment process, food-grade sodium carbonate and calcium sulfate were used for pretreatment to adjust the pH value of the pretreated bine to 11.0. The ratios of sodium/strontium and sodium/calcium in the pretreated brine were 1183:1 and 105:1, respectively. The strontium content of the table salt product manufactured according to the above process was 73 mg/kg.

### Example 4

The used raw brine contained 131500 mg/L sodium, 4580 mg/L calcium and 37 mg/L strontium. The raw brine was concentrated and salt was crystallized according to the process shown in FIG. 3, but without pretreatment. The table salt product obtained according to the flow sheet shown as Example 1 had a strontium content of 31 mg/kg.

### Example 5

The used raw brine was the same to that used in Example 4. The raw brine was concentrated and salt was crystallized according to the process shown in FIG. 3, but the pretreatment of the raw brine was conducted with bipolar membrane electrodialysis. The ratios of sodium/strontium and sodium/calcium in the pretreated brine were 2980:1 and 120:1, respectively. The table salt product obtained according to the flow sheet shown as Example 1 had a strontium content of 105 mg/kg.

### Example 6

The used raw brine was the same to that used in Example 4. The raw brine was concentrated and salt was crystallized according to the process shown in FIG. 3, but the pretreatment of the raw brine was conducted with ion exchange. The ratios of sodium/strontium and sodium/calcium in the pretreated brine were 3300:1 and 100:1, respectively. The table salt product obtained according to the flow sheet shown as Example 1 had a strontium content of 87 mg/kg.

### Example 7

The raw brine and pretreatment of the brain were the same to those used in Example 2. The raw brine was concentrated and salt was crystallized according to the process shown in FIG. 4. The brine from brine-mixing tank was pumped into the V-effect evaporator, and the concentrated brine from this effect evaporator was countercurrently pumped into the IV-effect evaporator. The brine was further concentrated in this effect evaporator and the obtained concentrated brine was evenly and countercurrently pumped in the I, II and III-effect evaporators. The discharged salt slurry from each evaporator was washed with the mixed brine preheated by the condensed water, and the temperature of the salt slurry reached about 52° C. The salt slurry from the I, II and III evaporators were processed in succession by the thickener, centrifuge and dryer of Group A thickening and drying equipment to obtain strontium-rich table salt A. The salt slurry from the IV and V evaporators were processed in succession by the thickener, centrifuge and dryer of Group B thickening and drying equipment to obtain strontium-rich table salt B. It was determined that strontium-rich table salt A had a strontium content of 123 mg/kg, while strontium-rich table salt B had a strontium content of 381 mg/kg.

### Example 8

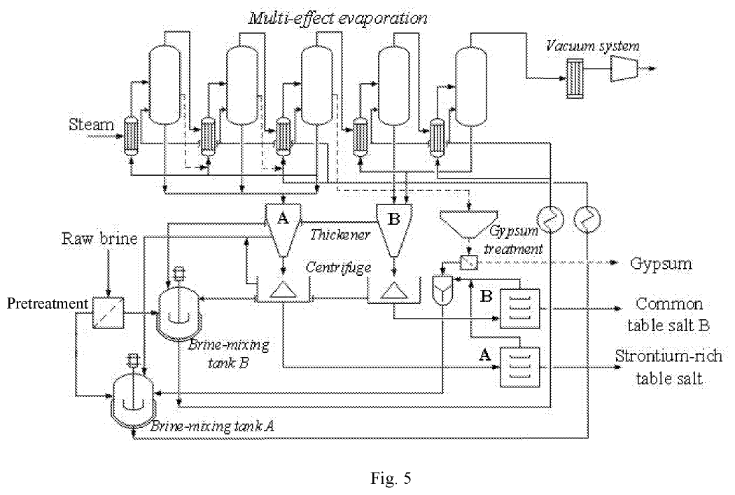

The raw brine used was the same to that used in Example 4. The raw brine was concentrated and salt was crystallized according to the process shown in FIG. 5. The raw brine was firstly pretreated with GE-DK1812 nanofiltration membrane under 3 Mpa pressure. The penetrated brine was mixed in brine-mixing tank B and then pumped into the V-effect evaporator. The concentrated brine from this effect evaporator was countercurrently pumped into the IV-effect evaporator for further concentration and salt crystallization. The salt slurry discharged from the IV and V-effect evaporators was washed with the preheated mixed brine from brine-mixing tank B, and then further processed in succession by the thickener, centrifuge and dryer of Group B thickening and drying equipment to obtain common table salt. The strontium content in this common table salt was determined to be 10 mg/kg. The retained brine by nanofiltration pretreatment had a sodium/ strontium ratio of 1500:1, and a calcium/strontium ratio of 128:1. This retained brine was mixed in brine-mixing tank A and then pumped into the III-effect evaporator. The concentrated brine from this effect evaporator was countercurrently and evenly pumped into the I and II-effect evaporators for further concentration and salt crystallization. The salt slurry discharged from the I, II and III-effect evaporators was washed with the preheated mixed brine from brine-mixing tank A, and then further processed in succession by the thickener, centrifuge and dryer of Group A thickening and drying equipment to obtain strontium-rich table salt. The strontium content in this strontium-rich table salt was determined to be 446 mg/kg.

1. Table salts containing 50 to 600 mg/kg of strontium;

2. The table salts according to claim 1, wherein the said table salts further contains sodium chloride of ≥99.1 wt %, sulfate ion of ≤0.4 wt % and moisture of ≤0.3 wt %

3. The table salts according to claim 1, wherein the said strontium exists in one or more forms of strontium chloride, strontium sulfate or strontium carbonate.

4. Methods for manufacturing the said table salts provided by claims 1-3 comprising the steps of:
a) Pretreatment of the raw brine to obtain pretreated brine;
b) Evaporation of the said pretreated brine obtained in step a) by a multi-effect evaporation process to obtain concentrated brine and gypsum mother liquor;
c) Post-treatment of the concentrated brine obtained in step b) by thickening and drying to obtain off-gas and the said table salts.

5. The method according to claim 4, wherein the raw brine is mining brine;

6. The method according to claim 4, wherein the mass ratio of sodium-to-strontium;

7. The method according to claim 4, wherein the said pretreatment in step a) is selected one or more combination of pH adjustment, electrodialysis, ion exchange, and membrane filtration treatments;
Preferably, the pH adjustment is performed by using one or more combinations of sodium carbonate, sodium bicarbonate, sodium hydroxide, calcium chloride, calcium sulfate, calcium carbonate and calcium oxide;
Preferably, the pH of the pretreated brine is 7-11;
Preferably, the electrodialysis treatment is bipolar membrane electrodialysis;
Preferably, the membrane filtration treatment is nanofiltration;
Optionally, the multi-effect evaporation in step b) is two to six-effect evaporation;
Preferably, the multi-effect evaporation is performed by concurrent, countercurrent, cross-flow or combination thereof;
Preferably, the concentrated brine is obtained from the pretreated brine in step b) by a countercurrent multi-effect evaporation;
Preferably, the gypsum mother liquor is obtained from the pretreated brine in step b) by a concurrent multi-effect evaporation;
Preferably, the temperature for multi-effect evaporation decreases at a temperature gradient of 10-30° C. from the first effect to the last effect:
Preferably, the first effect evaporation is performed at a temperature of 120-180° C. and an absolute pressure of 0.2-10 MPa.

8. The method according to claim 4, wherein it further comprises the steps of:
d) centrifugal treatment of the said gypsum mother liquor obtained in step b) to obtain gypsum and supernatant;
e) treatment of the said off-gas obtained in step c) by a dry de-dusting and further by a wet de-dusting with the said supernatant obtained in step d) or the condensed water obtained in the multi-effect evaporation process in step b) to obtain de-dusting brine;
f) mixing and evaporate the said de-dusting brine obtained in step e) with the said pretreated brine obtained in step a) to obtain the said table salt;
Optionally, step f) is performed when the concentration of salt in the de-dusting brine obtained in step e) reaches 150-300 g/L;
Preferably, step b) further comprises the step of obtaining concentrated brine with different strontium contents from the evaporation chamber of different effects of the multi-effect evaporation system.

9. A system for manufacturing the said table salt, wherein the said system comprises:
Pretreatment equipment that is used for pretreating the raw brine to obtain pretreated brine;
Multi-effect evaporation equipment that is connected with the pretreatment equipment, and is used to obtain concentrated brine and gypsum mother liquor by multi-effect evaporation of the pretreated brine from pretreatment equipment.
Thickening and drying equipment that is connected with the multi-effect evaporation equipment, and is used to thicken and dry the concentrated brine obtained from the multi-effect evaporation equipment to obtain the off-gas containing salt dust and the said table salts;

10. The system for manufacturing the said table salts according to claim 9, wherein the said system further comprises:
Gypsum treatment equipment that is connected with the multi-effect evaporation equipment, and is used to centrifuge the gypsum mother liquor obtained from the multi-effect evaporation equipment to obtain gypsum and supernatant;
Dry de-dusting equipment that is connected with the thickening and drying equipment, and is used to remove the salt contained in off-gas obtained by the thickening and drying equipment;
Wet de-dusting equipment that is connected with the said dry de-dusting equipment, the said gypsum treatment equipment and/or the said multi-effect evaporation equipment, and is used to further remove the residual salt contained in the treated off-gas from the said dry de-dusting equipment with the supernatant from the said gypsum treatment equipment or the condense water from the said multi-effect evaporation equipment; and
Brine mixing equipment that is connected with wet de-dusting equipment, pretreatment equipment and multi-effect evaporation equipment, and is used to mix the de-dusting brine from the said wet de-dusting equipment with the pretreated brine from the pretreatment equipment and transfer the mixed brine back to the multi-effect evaporation equipment.
